(19) United States
(12) Patent Application Publication
(10) Pub. No.: US 2015/0081932 A1
(43) Pub. Date: Mar. 19, 2015

(54) SCHEDULING, IN-MEMORY CODING, DATA WIRE MATCHING, AND WIRE PLACEMENT FOR WIRE POWER REDUCTION

(71) Applicants: Karthik RAMANI, San Jose, CA (US); Santhosh PILLAI, San Jose, CA (US); John BROTHERS, Calistoga, CA (US); Santosh ABRAHAM, Pleasanton, CA (US)

(72) Inventors: Karthik RAMANI, San Jose, CA (US); Santhosh PILLAI, San Jose, CA (US); John BROTHERS, Calistoga, CA (US); Santosh ABRAHAM, Pleasanton, CA (US)

(21) Appl. No.: 14/178,268

(22) Filed: Feb. 11, 2014

Related U.S. Application Data
(60) Provisional application No. 61/880,158, filed on Sep. 19, 2013.

(51) Int. Cl. G06F 5/00

(52) U.S. Cl. CPC G06F 5/00
USPC 710/54

(57) ABSTRACT

According to one general aspect, an apparatus may include a source unit, a destination unit, and a plurality of interconnect wires. The source unit may be configured to store, at least temporarily, data, wherein the data is written to a storage structure in a plurality of data structures. The destination unit may be configured to receive at least a portion of the data from the source unit. The plurality of interconnect wires may be configured to transmit, the at least a portion of the data between the source unit and the destination unit. The source unit may include a transmission management unit configured to re-order the data to a re-ordered format, and wherein the re-ordered format is configured to reduce power incurred during the transmission of the at least a portion of the data across the plurality of interconnect wires.

### CROSS-REFERENCE TO RELATED APPLICATION

This application claims priority under 35 U.S.C. §119 to Provisional Patent Application Ser. No. 61/880,158, entitled “SCHEDULING, IN-MEMORY CODING, DATA WIRE MATCHING, AND WIRE PLACEMENT FOR WIRE POWER REDUCTION IN SOCS” filed on Sep. 19, 2013. The subject matter of this earlier filed application is hereby incorporated by reference.

### TECHNICAL FIELD

This description relates to the transmittal of data, and more specifically to the transmittal of data via wires of an integrated circuit.

### BACKGROUND

Data transfer is traditionally a power hungry operation. This is often true even within an integrated circuit (IC), such as a processor, system-on-a-chip (SoC), etc. Further, data transfer power is likely to increase as circuits have transitioned to wide data busses (e.g., 64-bit, 128-bit, etc.), as opposed to the previously smaller data busses (e.g., 32-bits, etc.). Also, as SOCs integrate a greater number of processing units (e.g., a central processing unit (CPU), graphics PU (GPU), remote PU (RPU), power or physics PU (both PPU), etc.), the amount of data transferred and the power required for that transfer is likely to increase.

Generally, a major portion of the power incurred in data transfer is due to the wires that move data from source to destination. As such, the portion of power consumption due to data transfer wires compared to the total IC power consumption is expected to increase as the amount of data transfer wires increase compared to the number of logic gates.

In general, there are three major components of wire power consumption or power usage. Wire switching power is a form of wire power that is incurred when a signal transitions from 0 (low) to 1 (high) or 1 to 0 in consecutive cycles. Wire coupling power occurs if signals on adjacent wires transition in opposite directions (e.g., low-to-high transition occurs while a high-to-low transition occurs on the adjacent wire, etc.). More power is incurred than when adjacent signals transition in same direction. Repeater or buffer power occurs for relatively long wires. Traditionally, buffers or repeaters are inserted along the length of a wire to amplify the signal and break the capacitive load between the source and destination of the wire.

### SUMMARY

According to one general aspect, an apparatus may include a source unit, a destination unit, and a plurality of interconnect wires. The source unit may be configured to store, at least temporarily, data, wherein the data is written to a storage structure in a plurality of data structures. The destination unit may be configured to receive at least a portion of the data from the source unit. The plurality of interconnect wires may be configured to transmit, the at least a portion of the data between the source unit and the destination unit. The source unit may include a transmission management unit configured to re-order the data to a re-ordered format, and wherein the re-ordered format is configured to reduce power incurred during the transmission of the at least a portion of the data across the plurality of interconnect wires.

According to another general aspect, a method may include storing data, wherein the data is written to a source unit in a plurality of data structures. The method may also include re-ordering the data to a re-ordered format, wherein the re-ordered format is configured to reduce power incurred during a transmission of the at least a portion of the data across a plurality of interconnect wires. The method may include transmitting at least a portion of data in the re-ordered format to a destination unit, wherein the transmission occurs via the plurality of interconnect wires.

According to another general aspect, a computer program product for transmitting data may be tangibly and non-transitorily embodied on a computer-readable medium. The computer program product may include executable code for execution on a data processing apparatus. The executable code may include instructions to receive data to be transmitted to a destination unit, wherein the data includes a plurality of data structures. The executable code may include instructions to re-order the data to a re-ordered format, wherein the re-ordered format is configured to reduce power incurred during a transmission of the at least a portion of the data across a plurality of interconnect wires. The executable code may include instructions to transmit at least a portion of data in the re-ordered format to a destination unit, wherein the transmission occurs the plurality of interconnect wires via a plurality of interconnect wires.

The details of one or more implementations are set forth in the accompanying drawings and the description below. Other features will be apparent from the description and drawings, and from the claims.

A system and/or method for transmitting data or information, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a table of an example embodiment of a number of encoding schemes in accordance with the disclosed subject matter.

FIG. 4 is a table of an example embodiment of a number of encoding schemes in accordance with the disclosed subject matter.

FIG. 5 is a block diagram of an example embodiment of a system in accordance with the disclosed subject matter.

FIG. 6 is a flowchart of an example embodiment of a technique in accordance with the disclosed subject matter.

FIG. 7 is a schematic block diagram of an information processing system, which may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosed subject matter.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

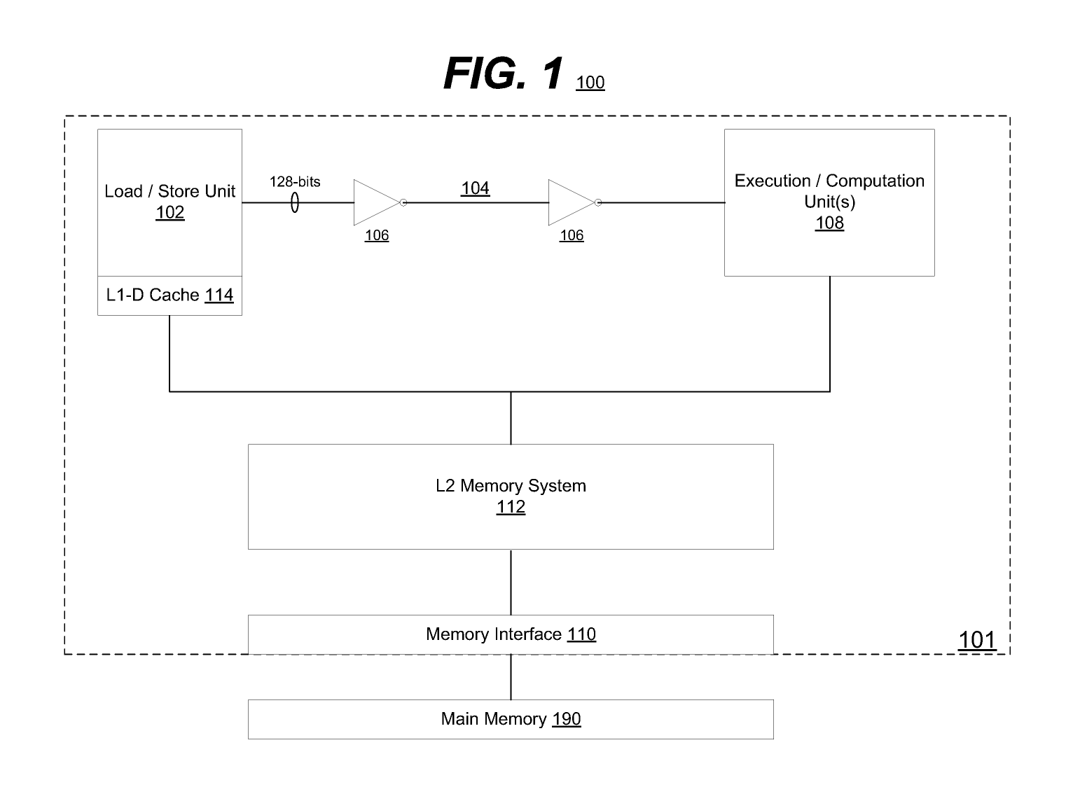

FIG. 1 is a block diagram of an example embodiment of a system 100 in accordance with the disclosed subject matter. In the illustrated embodiment, the system 100 may include a processor or other integrated circuit 101 (e.g., a CPU, a SoC, etc.) and one or more main memory circuits or chips 190 (e.g., a dual-in-line memory module (DIMM), etc.). It is understood that the above is merely one illustrative example used to establish a context for the disclosed subject matter and the disclosed subject matter is not limited to or by this sole example.

In the illustrated embodiment, the system 100 may include a number of components or portions that transfer data between themselves. For example, in one embodiment, the system 101 may include the main memory 190. In such an embodiment, the memory 190 may be configured to store data and/or instructions. Specifically the memory 190 may be configured to store the majority of the information used by the system 100. In some embodiments, the memory 190 may include volatile memory, non-volatile memory, or a combination thereof. In various embodiments, the memory 190 may include a plurality of tiers (e.g., DIMM, hard drive, optical memory, etc.), but for purposes of this figure it is assumed the memory 190 includes a DIMM or substantially equivalent memory device. It is understood that the above is merely one illustrative example to which the disclosed subject matter is not limited.

In various embodiments, processor 101 may include a level-2 (L2) memory system or cache 112. In such an embodiment, the L2 cache 112 may be configured to store data for relatively quick retrieval by the processor 101. The data stored in the L2 cache 112 may, in one embodiment, be a subset of the data stored by the main memory 190. In various embodiments, data may be transferred between the L2 cache 112 and the memory 190 (e.g., via a memory interface 110, etc.). In such an embodiment, these data transfers may incur one or more types of wire power (e.g., wire switching power, wire coupling power, buffer power, etc.), as described above. In the illustrated embodiment, the data transfer may include or employ one or more of the techniques described below in reference to the other figures.

Further, in various embodiments, the processor 101 may include one or more additional internal memories or caches or processing elements. In the illustrated embodiment, this is represented by the Level-1 Data (L1-D) cache 114. It is understood that the above is merely one illustrative example to which the disclosed subject matter is not limited. Again, in some embodiments, the L1-D cache 114 may be configured to store a subset of the data stored within the L2 cache 112. As described above, in various embodiments, data may be transferred between the L2 cache 112 and the L1-D cache 114 or any other memories coupled with the L2 cache 112. Data transfer may also occur between two processing elements such as between a CPU and GPU or between two GPUs or two processing elements. As described above, in such an embodiment, these data transfers may incur one or more types of wire power (e.g., wire switching power, wire coupling power, buffer power, etc.), as described above. In the illustrated embodiment, the data transfer may include or employ one or more of the techniques described below in reference to the other figures.

Likewise, the L1-D cache 114 may feed or provide data to a number of other hardware components or units. In one embodiment, such a unit may include a load/store unit (LSU) 102 that is configured to regulate the loading and storing of data from the one or more of the memories (e.g., L1-D cache 114). Again, the data transfer between the LSU 102 and the L1-D cache 114 may involve the wire power described above.

In various embodiments, the LSU 102 (or other execution unit) may transfer data with another execution or computation unit 108 (e.g., a floating-point unit (FPU), etc.). This allows the connection employed for such a data transfer to be examined is more detail. In one embodiment, the data transfer may occur over or via a series of wires or a bus 104, illustrated as a 128-bit bus. In such an embodiment, the bus 104 may include a plurality of wires running roughly in parallel, each wire may be configured to transmit one signal or bit of information. In such an embodiment, a data word (e.g., a 128-bit data word, etc.) may be transmitted in one clock cycle. Whereas a 256-bit word may take 2 clock cycles, etc.

In such an embodiment, the transfer across the bus 104 may include both spatial and temporal components. The spatial aspect may include which bit of data is being transmitted across each individual wire. This may include interactions between two or more wires (e.g., wire coupling power, etc.). In various embodiments, these interactions may be affected by the distance between the various wires (e.g., horizontally, vertically, differing metal/conductor layers, intervening signals, etc.) and may involve the capacitive and inductive interactions between the individual wires. The temporal aspect may include which bit value (e.g., high, low, 1, 0, etc.) follows other bit values down or along the same wire (e.g., how bit values change over time; wire switching power, etc.). Further, in various embodiments, the transmission path or bus 104 may include one or more repeaters or buffers 106. Such buffers 106 are usually (but not always) included for relatively long data busses 104 or when a boundary between circuits is experienced (e.g., memory interface 110, etc.). In such an embodiment, the bus 104 may incur power or consumption due to the repeaters 106, as described above. It is understood that the above are merely a few illustrative examples to which the disclosed subject matter is not limited.

In the illustrated embodiment, it is shown that there are many possible places and ways in which data transfers may occur between differing portions of an integrated circuit (e.g., processor 101, etc.) or a system 100. It is understood that the disclosed subject matter, in whole or part, may be employed to reduce power consumption between one or more of these data transfer areas.

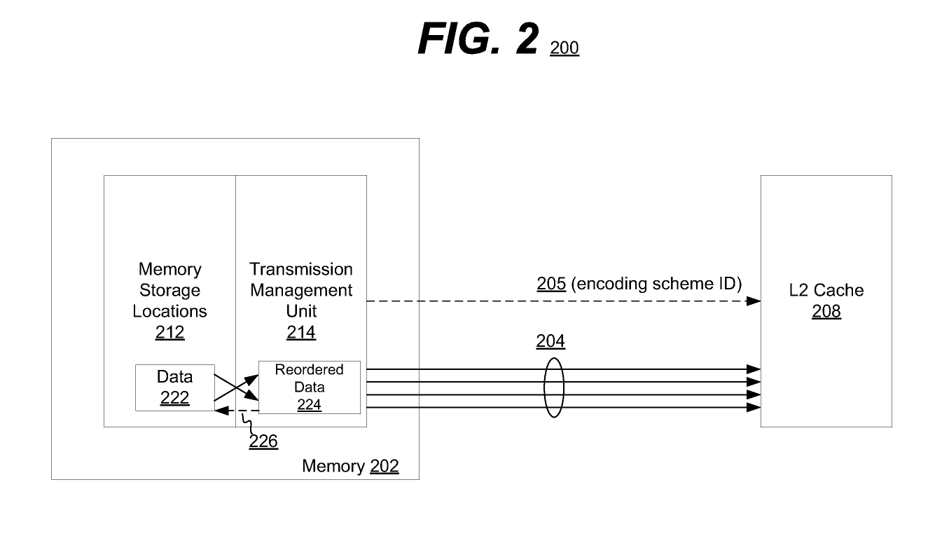

FIG. 2 is a block diagram of an example embodiment of a system 200 in accordance with the disclosed subject matter. In the illustrated embodiment, a data transfer may occur between the memory 202 and the L2 cache 208. In some embodiments, the memory 202 may include the main memory (e.g., memory modules, etc.). In another embodiment, the memory 202 may be included as part of another chip or circuit (e.g., a memory management unit (MMU), a northbridge, a chipset component, etc.). It is understood that the above are merely a few illustrative examples to which the disclosed subject matter is not limited.

In the illustrated embodiment, the data transfer may occur via a plurality of interconnect wires, generally referred to as the data bus 204. While only four wires or bits of the data bus 204 are illustrated it is understood that the number of bits or wires is often much greater (e.g., 128 bits, 256 bits, etc.).

In various embodiments, the memory 202 may include a plurality of memory storage locations 212 that are configured to actually store the data 222. During a data transfer, this data 222 (or a portion thereof) may be reordered or manipulated by a transmission management unit 214. This transmission management unit (TMU) 214 may be included by the memory 202. The various schemes or techniques employed by the transmission management unit 214 are described below. In some embodiments, TMU 214 may request that other units or circuits perform one or more operations on the data (e.g., the actual re-ordering, etc.). In another embodiment, the TMU 214 may be configured to perform those tasks itself. In one embodiment, the re-ordering may actually change the data 222 in terms of the way it is stored, but in yet another embodiment, the re-ordering may only occur as the data 222 is placed on the data bus 204. It is understood that the above is merely one illustrative example to which the disclosed subject matter is not limited. The reordered data 224 may be transmitted via the data bus 204 to the receiving unit, in this case the L2 cache 208.

Historically, a number of encoding schemes have been developed in order to attempt to reduce switching and coupling power consumption. These schemes generally perform bit level manipulations to reduce wire switching power (e.g., bit inversion, Grey encoding, cache based encoding, etc.). In general, these schemes have operated at the circuit-level based upon abstract details or assumptions about actual data and what that data represents. Often because these schemes have assumed that the data is random or unpredictable, they have not been optimized or taken advantage of features had they assumed the data to be known or predictable.

In the illustrated embodiment, one may assume that the data may be relatively known or at least partially predictable. In such an embodiment, the transmission management unit 214 may include, at least partially, knowledge of the format of the data structure 222. For example, if one assumes the data 222 to be graphical in nature, optimizations may be made based upon the expected correlation between the portions of the data. In a more specific example, the data may include Red-Green-Blue (RGB) encoded information in which each pixels color is represented by three distinct color values.

In general, the data 222 may include a plurality of data structures. In various embodiments, these data structures may include a series of repeating and/or interleaved fields. Returning to the RGB example, the data 222 may include a plurality of data structures that each include a RGB triplet, in which the R, G, and B (respectively) fields are interleaved amongst the other color value fields. It is understood that the above are merely a few illustrative examples to which the disclosed subject matter is not limited. For example, the data 222 may include any arbitrary data structures (e.g., audio information, database fields, a series of empirical measurements, etc.).

In the illustrated embodiment, the transmission management unit 214 may be configured to re-order the data 222 to a re-ordered format 224. In such an embodiment, the re-ordered format 224 may be configured to reduce power incurred during the transmission of the at least a portion of the data 224 across the plurality of interconnect wire 204, as described above. In such an embodiment, the reordering may occur based, at least in part, upon assumptions or expectations made about the data 222 and the data structures used to represent that data 222.

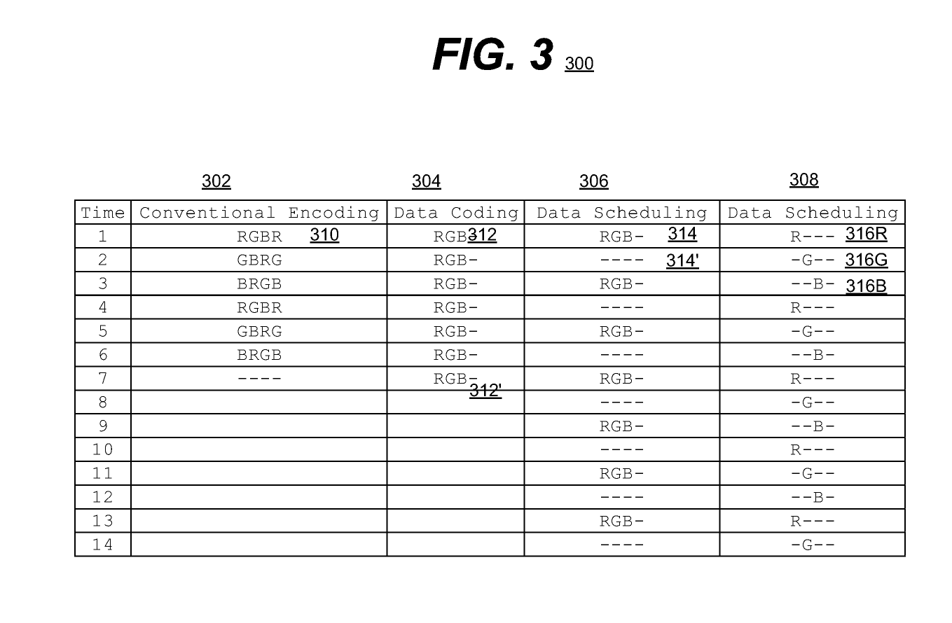

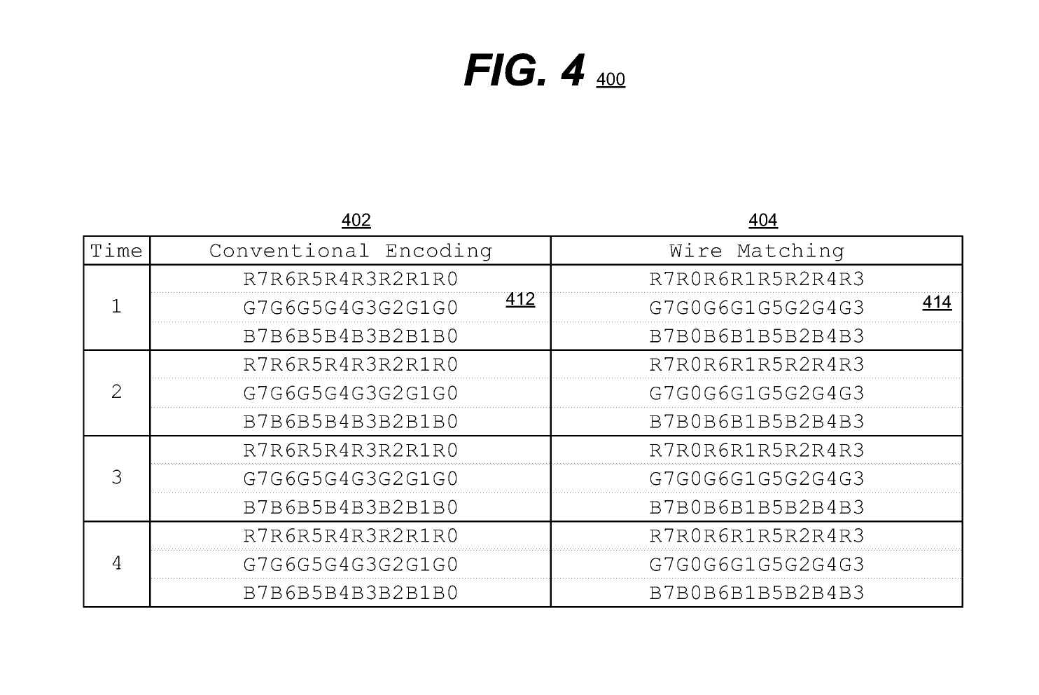

As described below, in various embodiments, the transmission management unit 214 may be configured to re-order the data 222 according to one or more of at least three general schemes. These three schemes may include (1) data coding or re-arranging the layout in order to reduce transmission power or consumption, (2) data scheduling or transmission re-ordering that changes the timing of the data transmission, or (3) matching the data to particular wires of the data bus 204. It is understood that the above are merely a few illustrative examples to which the disclosed subject matter is not limited. These schemes will now be explained in reference to FIGS. 3 and 4, with further reference to FIG. 2.

FIG. 3 is a table 300 of an example embodiment of a number of encoding schemes in accordance with the disclosed subject matter. Specifically, column 302 shows a traditional or conventional way in which RGB encoded is transmitted across a data bus or interconnect wires (e.g., wires 204, etc.). It is understood that the above is merely one illustrative example to which the disclosed subject matter is not limited.

In this example, the RGB data structure may include three 8-bit color values, totaling 24-bits. However, most data busses include a number of wires based on the powers of 2 (e.g., 8 wires, 16 wires, 32 wires, 64 wires, etc.). In order to transfer the data as quickly and efficiently as possible, the series of RGB data structures are concatenated into a contiguous stream of data. This stream of data is then divided into chunks according to the width of the data bus (e.g., 32-bits, etc.) and transmitted, one chunk per clock cycle across the data bus.

In the illustrated embodiment, this has the effect of causing the fields of the data structures to rotate across the various wires or bits of the data bus. For example in the first clock cycle the data word includes the fields “RGBR”, where the first R, the G, and the B all belong to the first data structure or pixel, and the second R being the R of the second data structure or pixel. In the second clock cycle, the data word includes the fields “GBRG, where the first G, and the B belong to the second data structure or pixel, and the R and the second G belong the third data structure or pixel. Likewise, the third clock cycle includes the fields “BRGB”. The fourth clock cycle includes the fields “RGBR”, and so on.

As described above, when the value on a wire (or set of wires) changes from high-to-low or from low-to-high, between two clock cycles, power is lost due to wire switching. In such an embodiment as shown in column 302, as there is expected to be little if no correlation between the first pixel's R field and the second pixel's G field, the amount of power incurred along the wires used to transmit those fields is expected to be random or unpredictable.

In various embodiments, the data structures (e.g., RGB triplets, etc.) may include a series of repeating interleaved fields (e.g., an R field, a G field, etc.). In such an embodiment, the transmission management unit may be configured to re-format the portion of the data such that each respective field of the data structures are transmitted via a same respective portion of the interconnect wires. In another embodiment, each of the data structures may include a number of bits less than the bit width of the plurality of interconnect wires or less than a modulus of the bit width of the interconnect wires. For example, an RGB pixel value may include 24-bits (8-bits times 3 color value fields) and the wires may be 32-bits wide. In such an embodiment, the transmission management unit may be configured to, during transmission, insert one or more extra bits into the data structure such that each data structure aligns with the plurality of interconnect wires.

These two embodiments are illustrated by column 304. In the illustrated embodiment, instead of treating the stream of pixel values as a contiguous stream of data, the stream of pixel values are broken into chunks such that only one pixel value is transmitted per clock cycle. As the pixel value takes only 24-bits but the wire is 32-bits wide, additional placeholder or garbage data is added to the data stream to pad the values to reach the 32-bit width. This is represented by the “-” character in the diagram. In the illustrated embodiment, this is shown by the data chunk or packet 312, which includes the fields “RGB-” and is compared to the traditional data transmittal scheme of chunk 310 that includes the fields “RGBR”.

In various embodiments, this padding may take the place of zeros, or other values. In another embodiment, these “unused” or extra bits may be employed to transmit a second data stream (not shown). In another, embodiment, the padding or extra bits may be placed at any point amongst the wires, and not just the end, as illustrated. In yet another embodiment, if the width of the wires or bus is sufficient, multiple data structures may be transmitted simultaneously (e.g. a 128-bit bus may transmit 5 24-bit pixel values with only 8-bits of padding, etc.). It is understood that the above are merely a few illustrative examples to which the disclosed subject matter is not limited.

In various embodiments, this static data coding may increase the amount of time required to transfer data between two units or memories. For example, the traditional data transfer of column 302 may take 6 clock cycles. Conversely, due to the padding data, the data transfer of column 304 may take 7 cycles. This is illustrated by the additional data cycle 312′. However, the amount of power consumed by the data transfer is reduced.

One of the reasons the amount of power is reduced is, to use the current specific example, because there is often a very high correlation between color values (e.g., R values) of different pixels within an image. As such, the data transfer scheme of column 304 assures that all the values for a given color (e.g., R, etc.) are transmitted via the same wires or portion of the interconnection wires in consecutive cycles. Because the color values are highly correlated, the number of times or frequency in which the value on the wire switches from high-to-low or low-to-high is minimized or reduced. Therefore, the amount of power consumed due to wire switching is reduced. It is understood that the above is merely one illustrative example to which the disclosed subject matter is not limited and that such a technique may be employed anytime data with regular and correlated data fields is encountered.

Another form of data encoding that may be employed that is dynamic in nature as opposed to static. In such an embodiment, the data transmittal or encoding scheme may not rely solely upon the expected nature of the data structure and correlation between the plurality of data structures. The dynamic embodiment of this encoding scheme may include analyzing the data to determine where correlations exist within the data and then re-arranging the data to take advantage of those correlations.

In such an embodiment, the transmission management unit (TMU) may be configured to analyze the graphical data to determine one of a plurality of encodings that minimizes a frequency of change in the graphical data. The TMU may be configured to re-order the graphical data based upon the one of a plurality of encodings. The TMU may be configured to then transmit the graphical data across the plurality of interconnect wires employing the one of a plurality of encodings. The TMU may also be configured to transmit an indicator to the execution unit indicating which of the plurality of encodings was employed.

Returning to the specific example of a graphical image (or video, which is typically a series of images). Traditionally, a two-dimensional image of width X and height Y is stored in pitch linear format. For example, all pixels in row 1 are stored one after the other, followed by the pixels in row 2 and so on. These pixel values may be correlated, as described above.

However, such a straightforward encoding scheme does not always provide the highest or a sufficiently desirable level of correlation. For example, when an image has an edge or break between two objects the level of correlation decreases. To use a specific example, when an image transitions between a blue sky and the wall of a redbrick building, the level of correlation between the blue-sky pixels and the red brick pixels is very low. Therefore, a higher level of wire switching power would be expected when that piece of data is transmitted. In addition, as the image is stored in a left-to-right fashion, every time a row of that image hit the edge between the sky and the wall, the wire switching power would increase.

Instead of transmitting the image data in a format that includes the sharp break in correlation when scanning from left to right (pitch linear format), the data may be re-ordered or re-encoded to use a different scanning or pixel order that includes a higher correlation amongst pixels. For example, all the sky data may be grouped together, and then the wall data may be grouped together, allowing the wire switching power to occur only when the entire sky block of data is done and not every time a row is processed. In a specific embodiment that involves video or other time-dependent data, the data may be re-ordered not just in to spatial domain but also temporally.

Unfortunately, the level of correlation for each encoding scheme is dependent upon the image actually displayed (e.g., a picture of an ocean may be very highly correlated for a left-to-right encoding, etc.). As such, the level of correlation may be determined or computed dynamically as each image is first stored within the memory or being transmitted.

In one embodiment, the TMU or other determining entity may be configured to test the level of correlation across a number of encoding schemes (e.g., Pitch linear format, transposed linear format, Morton order, Inverse Morton order, etc.) and then pick the encoding scheme with the highest correlation. In another embodiment, a threshold value of correlation may be set and then the first encoding scheme that reaches or exceeds that threshold value may be employed. It is understood that the above are merely a few illustrative examples to which the disclosed subject matter is not limited.

In such an embodiment, once the desired re-ordering or encoding scheme is determined the data may be re-encoded to maximize or increase the level of correlation. Then the transmittal scheme shown in column 304 may be employed for the actual transmission across the interconnect wires or bus. In such an embodiment, the data fields (e.g., R, G, or, B, etc.) may be specifically placed on the same wires each consecutive cycle and the pixel order may have been altered, such that the amount of wire switching is reduced, as described above.

In various embodiments, the re-ordering may occur during transmittal between units, as shown in FIG. 2. However, in another embodiment, the re-encoding or re-ordering may occur upon the entry of the data into the memory. This is illustrated by the arrow 226 of FIG. 2. In such an embodiment, the memory 202 may receive the data 222 and then pass it to the TMU 214 for inspection, determination of the desired encoding scheme or order of the plurality of data structures, and re-ordering. Then the reordered data 224 may be stored within the memory locations 212 as the new data 222. In various embodiments, the reordered data 224 may be transmitted between various levels of memory (e.g., L2 cache, L1 cache, etc.) and then re-reordered back into the original format at its final destination (e.g., a FPU, etc.). It is understood that the above is merely one illustrative example to which the disclosed subject matter is not limited.

In various embodiments, the determination of the desired encoding scheme or format, and the action of re-ordering the data may be performed by the TMU 214, firmware, a driver, software, or a combination thereof. For illustrative purposes the TMU 214 is shown as the component performing the reordering however it is understood that the TMU 214 may not in all embodiments be a solely hardware component. However, that is not to say that the TMU 214 is not a hardware circuit in various embodiments.

In various embodiments, it may be desirable to inform the receiving or destination unit (e.g., the L2 cache 208 of FIG. 2, etc.) which encoding scheme is being employed. In such an embodiment, an additional wire(s) may be added to the interconnect bus or wires 204 of FIG. 2. In such an embodiment, once the reordered data 224 is received by the destination unit 208, the destination unit 208 may be configured to examine the indicator or encoding scheme identifier (ID) 205 received via the additional wire, and properly re-reorder or decode the reordered data 224 (e.g., from Morton order to pitch linear format, etc.). In various embodiments, this encoding scheme ID 205 may be included in the padded bits (e.g. as opposed to simple 0 bits, etc.). In yet another embodiment, the encoding scheme ID 205 may be transmitted prior to or after the transmission of the data. In one embodiment, the encoding scheme ID 205 may include 2-bits; although, it is understood that the above is merely one illustrative example to which the disclosed subject matter is not limited.

Returning to FIG. 3, another scheme for reducing the power consumption incurred by transmitting data may be the data scheduling scheme illustrated by column 306. In general, the interconnect between two blocks or unit is designed to support a peak or maximum level of data traffic or transfer. However, on average, that high level of data transfer is not required. It may not be necessary for the 192-bits of data shown in column 302 to be transferred in 6 cycles. In another example, the designing engineer may have provided enough interconnect wires to send 128-bits of data over 8 wires in 16 cycles. However, if the one is only transferring 64-bits of data, that data may be scheduled in such a way as to reduce power consumption.

In such an embodiment, the transmission management unit may be configured to determine a desired throughput between the source unit and the destination unit. In such an embodiment, if the desired throughput is less than a maximum bandwidth of the plurality of interconnect wires, the TMU may be configured to time-multiplex the transmission of the portion of the graphical data such that only a portion of the plurality of interconnect wires are employed simultaneously.

In some embodiments, a data transfer or a computer architecture may be able to tolerate a few cycles of additional latency (e.g., video, GPU, etc.). In such an embodiment, it may be possible to re-order data to maximize or increase power efficiency at little to no performance cost.

Column 306 illustrates such an embodiment in which data is only transmitted every other cycle. In one embodiment, this may be combined with the scheme shown in column 304. In such an embodiment, the first cycle the data “RGB-” may be transmitted as chunk 314. In the alternate cycle (illustrated by chunk 314′) either no data may be transmitted (allowing the wires to de-power naturally) or a preset value may be transmitted (e.g., all zeros, etc.).

In another embodiment, the TMU may be configured to divide the plurality of interconnect wires into substantially interleaved sub-portions, and transmit, in turn and at individual times, portions of the graphical data via respective sub-portions of the plurality of interconnect wires. As described above, power may be lost due to capacitive and/or inductive coupling between two or more of the interconnect wires. In such an embodiment, the power incurred is not due to sending two signals back-to-back or in the time domain, but due to sending two signals too close to one another or in the spatial domain.

In one embodiment, the data may be re-ordered or placed on alternate wires, such that coupling power is reduced. This is similar to the scheme described above in which the padding bits where added to the encoding of column 304. As described above, these padding bits may have been added, not at the beginning or end of the data structures but within the data structures (e.g., between the R and G fields, etc.).

In the current embodiment, a similar situation may occur but the fields of the data structure may be separated both by physical distance (separate wires or padding bits), but also by time. Column 308 illustrates one embodiment of this. In such an embodiment, the RGB data structure has been divided into the respective R, G, and B fields. Likewise the interconnect wires have been divided into dedicated wires of the respective fields. Then in three consecutive cycles (316R, 316G, and 316B) one of the color value fields is transmitted. While the embodiment of column 308 may not be preferred (e.g., for reasons of throughput, etc.), the clarity of the example shows the ability to schedule the transmittal of not only the data structures (e.g., RGB pixels, etc.), but also the scheduling of the transmittal of the fields or portions (e.g., R color value field, G color value field, etc.) within the data structures. Also, the partitioning or dividing of the interconnect wires into dedicated sub-portions is illustrated.

In yet another embodiment, the order of the data or data structures may be reordered such that switching and/or coupling power may be reduced. For example, in one embodiment, the data structures may be re-encoded similarly to that described above. In such an embodiment, the data may be re-ordered to maximize or increase the correlation between portions. In such an embodiment, additional bits or an encoding scheme ID may be added to aid reverse reordering by the destination unit.

FIG. 4 is a table 400 of an example embodiment of a number of encoding schemes in accordance with the disclosed subject matter. Specifically, column 402 shows a traditional or conventional way in which RGB encoded data is transmitted across a data bus or interconnect wires (e.g., wires 204, etc.). It is understood that the above is merely one illustrative example to which the disclosed subject matter is not limited.

In the illustrated embodiment, the RGB data structure includes 24 bits divided into 3 color value fields of 8-bits each. For purposes of illustrative simplicity, the data bus is also 24-bit wide. Cycle 412 illustrates each of the 24-bits of the data structure. For example, the bit R7 is the 7^{th} bit of the Red color value field. Likewise, R1 is the 1^{st}-bit of the Red color value field; G5 is the 5^{th} bit of the Green color value field, B3 is the 3^{rd} bit of the Blue color value field, etc. As is traditional, the bits of the various color value fields are transmitted in order across the interconnect wires.

Generally, with highly correlated data the most significant bit (MSB) of the data (or the respective field of the data) changes less frequently than the least significant bit (LSB) of the data. In the illustrated embodiment, this means that the 7^{th} bit of the sequential Red color values would change less often than the 0^{th} bit of sequential Red color values. Alternatively, put another way, the Red values of the pixels change slowly across an image more often than they change quickly. That is a red part of the image is likely to stay red and not suddenly turn blue or green, for example.

Unfortunately, this means that the wires used to transmit the LSB bits of the R, G, and B color value fields tend to have a relatively high switching power (as the values they transmit change often). Further, as adjacent wires (e.g., the R1 and R0 wires, etc.) switch, due to their proximity, the power due to coupling effects increases.

In various embodiments, the bits of the data or data structure may be re-ordered such that adjunct wires a less likely to switch at the same time. Column 404 illustrates such an embodiment. Cycle 414 illustrates a scheme in which, instead of sequential ordering, the bits of the color value fields have been re-ordered such that the MSBs are paired with their respective LSBs. For example, R7 is paired or now adjacent to R10 (instead of R6) Likewise, R6 is paired with R1, and so on. In various embodiments, this may be done not only within a color value field or within a portion of the data structure, but across different portions of the data structure.

In such an embodiment, the data may be analyzed to determine a series of statistics and identify which bits switch, when. In various embodiments, this information may be employed to route the bits via wires in order to reduce the effective coupling capacitance between the wires.

In one embodiment, the TMU may be configured to re-order a portion of the data according to a data wire matching scheme. As described above, in such an embodiment, the data wire matching scheme may include re-ordering a bit order of the portion of the data based, at least in part, upon a set of expected switching characteristics. In more specific embodiment, the matching scheme may include matching a more significant bit with a lesser significant bit. The scheme may also include grouping bits that are expected to switch in a common direction (e.g., from low-to-high, at the same time, etc.). In such an embodiment, the scheme may include re-ordering the bits of the portion of data such that adjacent bits are less likely to switch at the same time. It is understood that the above are merely a few illustrative examples to which the disclosed subject matter is not limited.

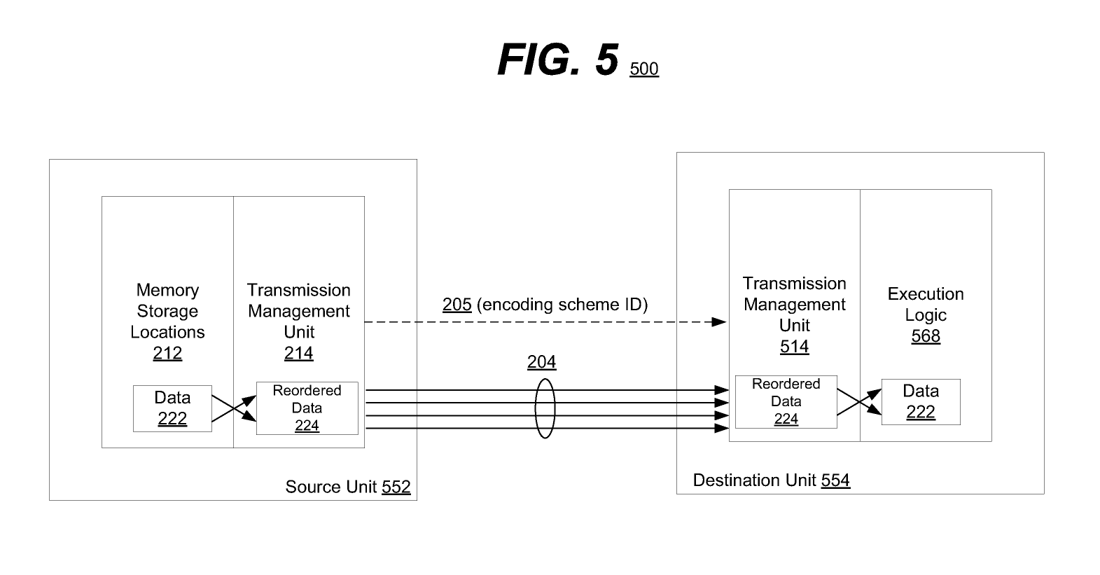

FIG. 5 is a block diagram of an example embodiment of a system 500 in accordance with the disclosed subject matter. In various embodiments, the system 500 may include two units, a transmitter or source unit 552 and a destination or receiver unit 554. As described above, the techniques disclosed herein may be employed between any two or more circuits that transfer data. FIG. 2 illustrated a transfer between a larger memory (e.g., memory 202) and a smaller memory (e.g., L2 cache 204). FIG. 5 illustrates a data transfer between two execution units of a processor, or more generally any two units or circuits. It is understood that the above are merely a few illustrative examples to which the disclosed subject matter is not limited.

In the illustrated embodiment, the source execution unit 552 (e.g., a LSU etc.) may include memory storage locations 212, and a transmission management unit 214, as described above. As described above, the source execution unit 552 may be configured to store data 222 and reorder that data. In such an embodiment, the reordered data 224 may be transmitted across the interconnect wires or data bus 204 to the receiver or destination unit 554 (e.g., a FPU, an ALU, etc.). In some embodiments, the transmittal may include an encoding scheme ID 205, as described above.

In various embodiments, the receiver execution unit 554 may include various portions of execution logic 568 configured to perform some logical operation on the data (e.g., a mathematical computation, etc.). In such an embodiment, the execution logic 568 may include a plurality of registers or other memory elements to store the received data 222.

In the illustrated embodiment, the receiver execution unit 554 may also include its own transmission management unit 514 configured to re-reorder the received reordered data 224 to form the data 222. In various embodiments, this reverse reordering process may be aided or based upon the encoding scheme ID 205. In some embodiments, the TMU 514 may include a cache to temporarily store the received data 224 until enough data 224 has been received to perform the reordering procedure.

As described above, in various embodiments, the TMUs 214 and/or 514 may include hardware, firmware, software, or a combination thereof. Further, in various embodiments, the data 222 may be reordered when first placed in the memory storage locations 212 and then transmitted without further reordering. It is understood that the above is merely one illustrative example to which the disclosed subject matter is not limited.

In yet another embodiment, one or more of the schemes disclosed herein may be employed to reduce the power consumption of the transmittal of the data 222. In one such embodiment, a first form of reordering (e.g., dynamic coding, etc.) may occur when the data 222 is first placed in the memory location 212 and a second form (e.g., wire matching, scheduling, etc.) may be employing when the data is actually transmitted. It is understood that the above is merely one illustrative example to which the disclosed subject matter is not limited.

In various embodiments, by employing the disclosed subject matter one can reduce average wire switching and coupling power. In some embodiments, in combination with smaller buffers, one can further reduce power. In yet another embodiment, an empty space below long wires may be employed to place static random access memories (SRAMs) or caches (e.g., an L2 cache, etc.) thereby enabling area reduction or optimizations to be made within an integrated circuit (e.g., a SoC, etc.). It is understood that the above are merely a few illustrative examples to which the disclosed subject matter is not limited.

In various embodiments, the disclosed subject matter may be employed across a number of process technologies (e.g., a 45 nm process technology, a 14 nm process technology, a 10 nm process technology, etc.), and may be more important as the spacing between wires is reduced. The disclosed subject matter is not limited to any specific bus width or wire spacing. In some embodiments, with the use of the disclosed subject matter the size of any buffers or repeaters may be reduced or removed, and additional power saved by their reduction.

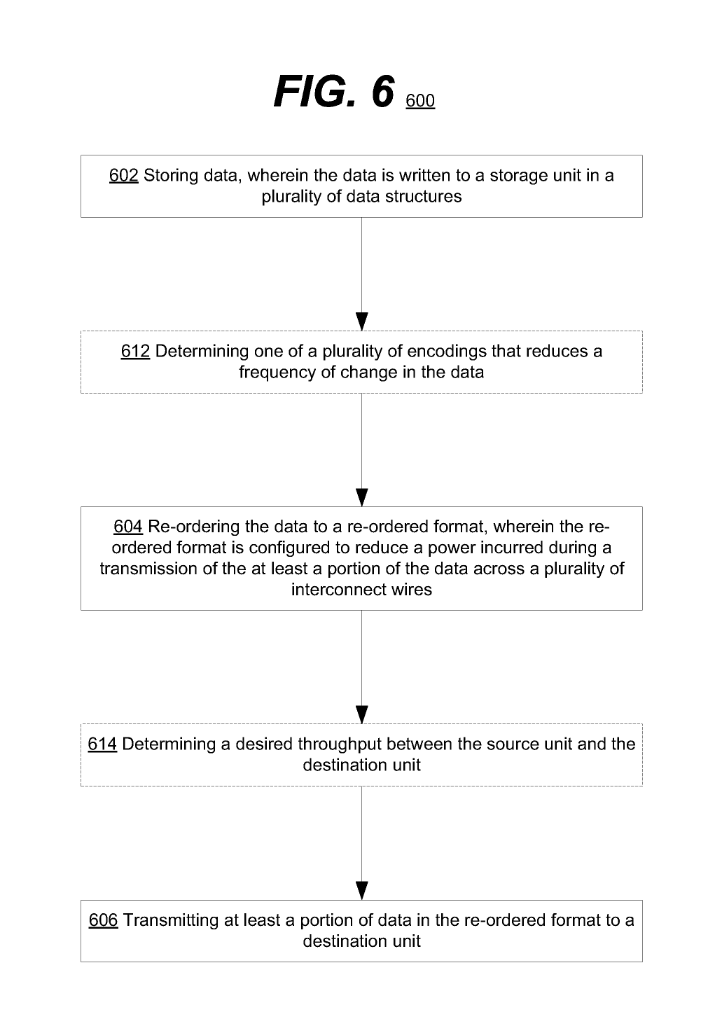

FIG. 6 is a flowchart of an example embodiment of a technique 600 in accordance with the disclosed subject matter. In various embodiments, the technique 600 may be used or produced by the systems such as those of FIG. 1, 2, 5, or 7. Furthermore, portions of technique 600 may be used to produce data transfers such those of FIG. 3 or 4. Although, it is understood that the above are merely a few illustrative examples to which the disclosed subject matter is not limited. It is understood that the disclosed subject matter is not limited to the ordering of or number of actions illustrated by technique 600.

Block 602 illustrates that, in one embodiment, data may be stored in a storage unit, as described above. In some embodiments, the data may be written to a storage unit in a plurality of data structures, as described above. In one embodiment, the data may include a level of correlation between the plurality of data structures, as described above. In various embodiments, one or more of the action(s) illustrated by this Block may be performed by the apparatuses or systems of FIG. 1, 2, 5, or 7, the memory of FIG. 1 or 2, or the source unit of FIG. 5, as described above.

Block 604 illustrates that, in one embodiment, the data may be re-ordered to a re-ordered format, as described above. In some embodiments, the re-ordered format may be configured to reduce power incurred during a transmission of the at least a portion of the data across a plurality of interconnect wires, as described above. In one embodiment, re-ordering may include re-formatting the portion of the data such that each respective field of the data structures is transmitted via a same respective portion of the interconnect wires, as described above. In various embodiments, one or more of the action(s) illustrated by this Block may be performed by the apparatuses or systems of FIG. 1, 2, 5, or 7, the memory of FIG. 1 or 2, or the source unit of FIG. 5, as described above.

In another embodiment, re-ordering may include re-ordering the portion of the data according to a data wire matching scheme, as described above. In one such embodiment, the data wire matching scheme includes re-ordering a bit order of the portion of the data based, at least in part, upon a set of expected switching characteristics, as described above. In various embodiments, the data wire matching scheme may include one or more techniques selected from a group consisting of the following: matching a more significant bit with a lesser significant bit, grouping bits that are expected to switch in a common direction, and re-ordering the bits of the portion of data such that adjacent bits are less likely to switch at a same time, as described above.

Block 606 illustrates that, in one embodiment, at least a portion of data may be transmitted in the re-ordered format to a destination unit, wherein the transmission occurs via the plurality of interconnect wires, as described above. In various embodiments, one or more of the action(s) illustrated by this Block may be performed by the apparatuses or systems of FIG. 1, 2, 5, or 7, the memory of FIG. 1 or 2, or the source unit of FIG. 5, as described above.

Block 612 illustrates that, in one embodiment, one of a plurality of encodings that reduces a frequency of change in the data may be determined, as described above. In such an embodiment, re-ordering may include re-ordering the data based upon the one of a plurality of encodings, as described above. In such an embodiment, transmitting may include transmitting an indicator to the destination unit indicating which of the plurality of encodings was determined, as described above.

Block 614 illustrates that, in one embodiment, a desired throughput between the source unit and the destination unit may be determined, as described above. In such an embodiment, transmitting may include, if the desired throughput is less than a maximum bandwidth of the plurality of interconnect wires, time-multiplexing the transmission of the portion of the data such that only a portion of the plurality of interconnect wires are employed simultaneously, as described above.

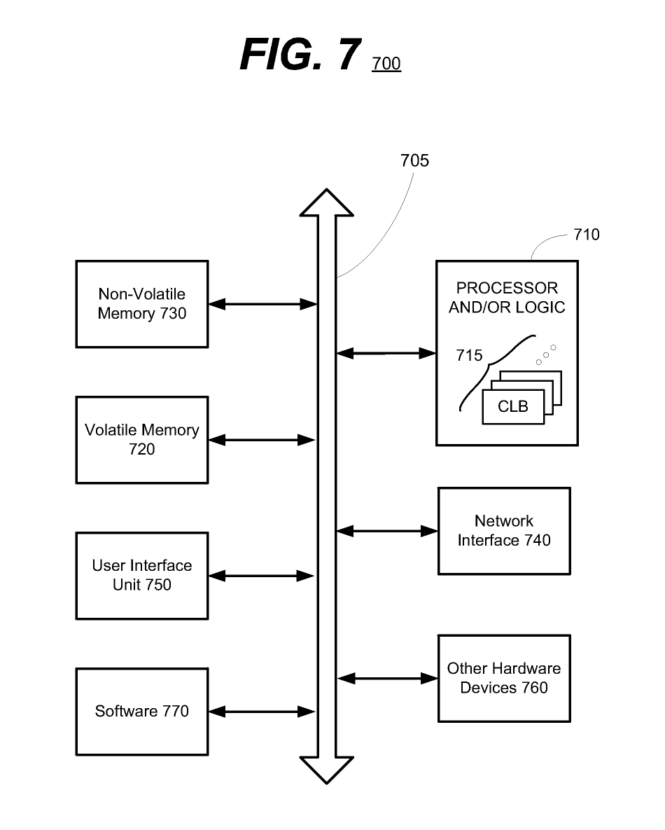

FIG. 7 is a schematic block diagram of an information processing system 700, which may include semiconductor devices formed according to principles of the disclosed subject matter. In one embodiment, each of the data structures may include a series of repeating interleaved fields, as described above.

Referring to FIG. 7, an information processing system 700 may include one or more of devices constructed according to the principles of the disclosed subject matter. In another embodiment, the information processing system 700 may employ or execute one or more techniques according to the principles of the disclosed subject matter.

In various embodiments, the information processing system 700 may include a computing device, such as, for example, a laptop, desktop, workstation, server, blade server, personal digital assistant, smartphone, tablet, and other appropriate computers, etc. or a virtual machine or virtual computing device thereof. In various embodiments, the information processing system 700 may be used by a user (not shown).

The information processing system 700 according to the disclosed subject matter may further include a central processing unit (CPU), processor, or logic 710. In some embodiments, the processor 710 may include one or more functional unit blocks (FUBs) or combinational logic blocks (CLBs) 715. In such an embodiment, a combinational logic block may include various Boolean logic operations (e.g., NAND, NOR, NOT, XOR, etc.), stabilizing logic devices (e.g., flip-flops, latches, etc.), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 700 according to the disclosed subject matter may further include a volatile memory 720 (e.g., a Random Access Memory (RAM), etc.). The information processing system 700 according to the disclosed subject matter may further include a non-volatile memory 730 (e.g., a hard drive, an optical memory, a NAND or Flash memory, etc.). In some embodiments, either the volatile memory 720, the non-volatile memory 730, or a combination or portions thereof may be referred to as a “storage medium”. In various embodiments, the memories 720 and/or 730 may be configured to store data in a semi-permanent or substantially permanent form.

In various embodiments, the information processing system 700 may include one or more network interfaces 740 configured to allow the information processing system 700 to be part of and communicate via a communications network. Examples of a Wi-Fi protocol may include, but are not limited to: Institute of Electrical and Electronics Engineers (IEEE) 802.11g, IEEE 802.11n, etc. Examples of a cellular protocol may include, but are not limited to: IEEE 802.16m (a.k.a. Wireless-MAN (Metropolitan Area Network) Advanced), Long Term Evolution (LTE) Advanced), Enhanced Data rates for GSM (Global System for Mobile Communications) Evolution (EDGE), Evolved High-Speed Packet Access (HSPA+), etc. Examples of a wired protocol may include, but are not limited to: IEEE 802.3 (a.k.a. Ethernet), Fibre Channel, Power Line communication (e.g., HomePlug, IEEE 1901, etc.), etc. It is understood that the above are merely a few illustrative examples to which the disclosed subject matter is not limited.

The information processing system 700 according to the disclosed subject matter may further include a user interface unit 750 (e.g., a display adapter, a haptic interface, a human interface device, etc.). In various embodiments, this user interface unit 750 may be configured to either receive input from a user and/or provide output to a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In various embodiments, the information processing system 700 may include one or more other hardware devices or components 760 (e.g., a display or monitor, a keyboard, a mouse, a camera, a fingerprint reader, a video processor, etc.). It is understood that the above are merely a few illustrative examples to which the disclosed subject matter is not limited.

The information processing system 700 according to the disclosed subject matter may further include one or more system buses 705. In such an embodiment, the system bus 705 may be configured to communicatively couple the processor 710, the volatile memory 720, non-volatile memory 730, the network interface 740, the user interface unit 750, and one or more hardware components 760. Data processed by the processor 710 or data inputted from outside of the non-volatile memory 730 may be stored in either the non-volatile memory 730 or the volatile memory 720.

In various embodiments, the information processing system 700 may include or execute one or more software components 770. In some embodiments, the software components 770 may include an operating system (OS) and/or an application. In some embodiments, the OS may be configured to provide one or more services to an application and manage or act as an intermediary between the application and the various hardware components (e.g., the processor 710, a network interface 740, etc.) of the information processing system 700. In such an embodiment, the information processing system 700 may include one or more native applications, which may be installed locally (e.g., within the non-volatile memory 730, etc.) and configured to be executed directly by the processor 710 and directly interact with the OS. In such an embodiment, the native applications may include pre-compiled machine executable code. In some embodiments, the native applications may include a script interpreter (e.g., C shell (csh), AppleScript, AutoHotkey, etc.) or a virtual execution machine (VM) (e.g., the Java Virtual Machine, the Microsoft Common Language Runtime, etc.) that are configured to translate source or object code into executable code which is then executed by the processor 710.

The semiconductor devices described above may be encapsulated using various packaging techniques. For example, semiconductor devices constructed according to principles of the present inventive concepts may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive, etc.). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a source unit configured to store, at least temporarily, data, wherein the data is written to a storage structure in a plurality of data structures;
a destination unit configured to receive at least a portion of the data from the source unit; and
a plurality of interconnect wires configured to transmit, the at least a portion of the data between the source unit and the destination unit,
wherein the source unit includes a transmission management unit configured to re-order the data to a re-ordered format, and wherein the re-ordered format is configured to reduce power incurred during the transmission of the at least a portion of the data across the plurality of interconnect wires.

2. The apparatus of claim 1 wherein each of the data structures includes a series of repeating interleaved fields; and
wherein the transmission management unit is configured to re-format the portion of the data such that each respective field of the data structures is transmitted via a same respective portion of the interconnect wires.

3. The apparatus of claim 1 wherein the plurality of interconnect wires comprises a bit width;
wherein each of the data structures includes a number of bits less than the bit width of the plurality of interconnect wires; and
wherein the transmission management unit is configured to, during transmission, insert one or more extra bits into the data structure such that each data structure aligns with the plurality of interconnect wires.

4. The apparatus of claim 1, wherein the data includes a level of correlation between the plurality of data structures; and
wherein the transmission management unit is configured to:
analyze the data to determine one of a plurality of encodings that minimizes a frequency of change in the data,
re-order the data based upon the one of a plurality of encodings,
transmit the data across the plurality of interconnect wires employing the one of a plurality of encodings, and
transmit an indicator to the destination unit indicating which of the plurality of encodings was employed.

5. The apparatus of claim 4, wherein the correlation between the plurality of data structures is both spatial and temporal.

6. The apparatus of claim 1, wherein the transmission management unit is configured to:
determine a desired throughput between the source unit and the destination unit, and
if the desired throughput is less than a maximum bandwidth of the plurality of interconnect wires,
re-ordering the transmission of the portion of the data in order to reduce power incurred during the transmission of the portion of the data across the plurality of interconnect wires, but such that the desired throughput between the source unit and the destination unit is at least met.

7. The apparatus of claim 1, wherein the transmission management unit is configured to:
determine a desired throughput between the source unit and the destination unit, and
if the desired throughput is less than a maximum bandwidth of the plurality of interconnect wires,
time-multiplex the transmission of the portion of the data such that only a portion of the plurality of interconnect wires are employed simultaneously.

8. The apparatus of claim 1, wherein the transmission management unit is configured to:
determine a desired throughput between the source unit and the destination unit; and
if the desired throughput is less than a maximum bandwidth of the plurality of interconnect wires,
divide the plurality of interconnect wires into substantially interleaved sub-portions, and
transmit, in turn and at individual times, portions of the data via respective sub-portions of the plurality of interconnect wires.

9. The apparatus of claim 1, wherein the transmission management unit is configured to:
re-order the portion of the data according to a data wire matching scheme; and
wherein the data wire matching scheme includes re-ordering a bit order of the portion of the data based, at least in part, upon a set of expected switching characteristics.

10. The apparatus of claim 9, wherein the data wire matching scheme includes one or more techniques selected from a group consisting of the following:
matching a more significant bit with a lesser significant bit;
grouping bits that are expected to switch in a same direction; and
re-ordering the bits of the portion of data such that adjacent bits are less likely to switch at a same time.

11. A method comprising:
storing data, wherein the data is written to a source unit in a plurality of data structures;
re-ordering the data to a re-ordered format, wherein the re-ordered format is configured to reduce power incurred during a transmission of the at least a portion of the data across a plurality of interconnect wires; and
transmitting at least a portion of data in the re-ordered format to a destination unit, wherein the transmission occurs via the plurality of interconnect wires.

12. The method of claim 11 wherein each of the data structures includes a series of repeating interleaved fields; and
wherein re-ordering includes:
re-formatting the portion of the data such that each respective field of the data structures is transmitted via a same respective portion of the interconnect wires.

13. The method of claim 11, wherein the data includes a level of correlation between the plurality of data structures;
the method further comprises determining one of a plurality of encodings that reduces a frequency of change in the data;
wherein re-ordering includes re-ordering the data based upon the one of a plurality of encodings; and
wherein transmitting includes transmitting an indicator to the destination unit indicating which of the plurality of encodings was determined.

14. The method of claim 11, wherein the method further includes:
determining a desired throughput between the source unit and the destination unit; and
wherein transmitting includes, if the desired throughput is less than a maximum bandwidth of the plurality of interconnect wires, re-ordering the transmission of the portion of the data in order to reduce power incurred during the transmission of the portion of the data across the plurality of interconnect wires, but such that the desired throughput between the source unit and the destination unit is at least met.

15. The method of claim 11, wherein the method further includes:
determining a desired throughput between the source unit and the destination unit; and
wherein transmitting includes, if the desired throughput is less than a maximum bandwidth of the plurality of interconnect wires, time-multiplexing the transmission of the portion of the data such that only a portion of the plurality of interconnect wires are employed simultaneously.

16. The method of claim 11, wherein re-ordering includes re-ordering the portion of the data according to a data wire matching scheme; and
wherein the data wire matching scheme includes re-ordering a bit order of the portion of the data based, at least in part, upon a set of expected switching characteristics.

17. The method of claim 16, wherein the data wire matching scheme includes one or more techniques selected from a group consisting of the following:
matching a more significant bit with a lesser significant bit;
grouping bits that are expected to switch in a common direction; and
re-ordering the bits of the portion of data such that adjacent bits are less likely to switch at a same time.

18. A computer program product for transmitting data, the computer program product being tangibly and non-transitorily embodied on a computer-readable medium and including executable code for execution on a data processing apparatus, the executable code comprising:
instructions to receive data to be transmitted to a destination unit, wherein the data includes a plurality of data structures;
instructions to re-order the data to a re-ordered format, wherein the re-ordered format is configured to reduce power incurred during a transmission of the at least a portion of the data across a plurality of interconnect wires; and
instructions to transmit at least a portion of data in the re-ordered format to a destination unit, wherein the transmission occurs the plurality of interconnect wires via a plurality of interconnect wires.

19. The computer program product of claim 18, wherein each of the data structures includes a series of repeating interleaved fields; and
wherein the executable code further comprises instructions to re-format the portion of the data such that each respective field of the data structures is transmitted via a same respective portion of the interconnect wires.

20. The computer program product of claim 18, wherein the data includes a level of correlation between the plurality of data structures; and
wherein the executable code further comprises instructions to:
determine one of a plurality of encodings that reduces a frequency of change in the data,
re-order the data based upon the one of a plurality of encodings, and
transmit an indicator to the destination unit indicating which of the plurality of encodings was determined.

21. The apparatus of claim 1 wherein the transmission management unit is configured to include, at least partially, knowledge of the format of the data structure and to re-order the data based upon the knowledge of the format of the data structure.
